(19) United States
(12) Patent Application Publication
(10) Pub. No.: US 2008/0018194 A1
(43) Pub. Date: Jan. 24, 2008

(54) CLAW-POLE TYPE SINGEL-PHASE MOTOR, CLAW-POLE TYPE SINGLE-PHASE MOTOR SYSTEM AND ELECTRIC PUMP, ELECTRIC FAN AND VEHICLE PROVIDED WITH CLAW-POLE TYPE SINGLE-PHASE MOTOR

(76) Inventors: Shigeru KAKUGAWA, Hitachi (JP); Fumio Tajima, Hitachi (JP); Masashi Kitamura, Mito (JP); Yuji Enomoto, Hitachi (JP); Motoya Ito, Hitachinaka (JP); Ryoso Masaki, Hitachi (JP); Shoji Ohiwa, Saitama (JP); Chio Ishihara, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/780,775

(22) Filed: Jul. 20, 2007

(30) Foreign Application Priority Data
Jul. 21, 2006 (JP) 2006-198878

(51) Int. Cl. H02K 37/14; H02K 11/00; H02K 21/12; H02P 7/06

(52) U.S. Cl. 310/257; 310/49 R; 310/156.46; 310/68 B

(57) ABSTRACT

A single-phase claw-pole type motor comprises a stator, which comprises a claw-pole type stator core and toroidally-wound single-phase stator windings, and a rotor that has alternate polarities, wherein a concave part or a convex part is provided on an air-gap surface of claws of the stator core. In addition, the stator core may be configured by compacting magnetic powder, and the single-phase claw-pole type motor may be driven by a converter that converts a direct current to an alternate current according to a position of the rotor.

### BACKGROUND OF THE INVENTION

1. Field of the Invention

The present invention relates to a claw-pole type motor.

2. Description of Related Art

The first measures practically used today for improving the fuel economy of a vehicle are to use an idle stop system, and the second measures are to employ a hybrid system in which a rotary electric machine is used for driving the vehicle. The problem with using those systems is that the idle stop system requires another pump driving source because the engine stops when the vehicle stops. On the other hand, a hybrid vehicle requires not only the idle stop system described above but also a driving motor or a starter generator, as well as a water pump for cooling its controller and, therefore, uses more motor-based electric pumps as their driving sources.

An example of a water pump using a three-phase brushless motor is disclosed in JP-A-2003-328986 as a typical example.

The structure of a general single-phase motor is disclosed in JP-A-2006-20459 and JP-A-2006-14575.

On the other hand, a single-phase motor, though low in cost, involves a drawback of a serious noise and vibration because, in principle, two torque pulsations are generated in one cycle of electrical angle. The motor used for this use, usually mounted in the passenger room or the engine room of a vehicle, must be very quite. A typical control example of this single-phase permanent magnetic motor is disclosed in JP-A-2004-88870.

Another drawback is that a hall device used for detecting the magnetic poles limits the operating temperature that, in turn, limits the usage rating in the engine room. A single-phase motor sensorless control method for solving this problem is disclosed in JP-A-7-63232.

### SUMMARY OF THE INVENTION

The driving motor of a water pump disclosed in JP-A-2003-328986 is structured as a three-phase motor in which the permanent magnetic rotor rotates in the laminated stator core on which the stator windings are wound. The problem is that the axis must be long enough to include not only the part in the stator core that contributes to the torque generation but also the parts, called coil ends, that are outside the stator core. In addition, to manufacture this motor, a thin steel plate is punched into the shape of a stator, the stator-shaped steel plates are laminated, and windings are wound on the stator winding storage part. This manufacturing method has the following three problems. The first problem is that not a small part of the material of the stator core is discarded with the result that the material utilization remains low and the cost reduction is not attained. The second problem is that, because the windings are wound on the coil storage part of the stator core, the space factor (winding area/winding storage area) is low and, as a result, compactness and high efficiency are not attained. The third problem is that the coil ends, which do not contribute to the torque generation as described above, have an adverse effect on high efficiency, compactness, and cost reduction.

The engine room, where those devices are stored, is a space crowded with various types of parts. In particular, a significant increase in the number of mounted parts for implementing recent advances in the hybrid system and the sophisticated functions requires that the parts stored therein be more light-weight and compact than those stored in other rooms.

General single-phase motors, disclosed in JP-A-2006-20459 and JP-A-2006-14575, have the structure of a single-phase motor in which the number of salient poles on the stator equals the number of permanent magnetic poles. This structure has the problems similar to those described above.

The control method disclosed in JP-A-2004-88870, which discloses an example of the typical control of torque pulsations, reduces torque ripples, to some degree, in a simple configuration.

However, this method does not fully reduce torque ripples when the number of rotations change, when the load changes, or when the temperature changes and, therefore, the problem is that torque ripples occur and vibrations and noises are generated.

The single-phase motor sensorless control disclosed in JP-A-7-63232 provides a power-off period near a point in time when the induced voltage of the single-phase permanent magnet motor switches between positive and negative, and generates an induced voltage between the windings to detect the rotor position (switching point of applied voltage) based on the determination whether the voltage is positive or negative.

Therefore, this configuration makes the sensorless operation simple. However, because the current-stop period is provided for outputting an induced voltage on the windings, this configuration basically decreases efficiency and increases pulsation torques, causing a problem that the motor generates large noises and vibrations.

The present invention provides a single-phase claw-pole type motor comprising a stator, which comprises a claw-pole type stator core and a toroidally-wound single-phase stator winding, and a rotor that has alternate polarities, wherein a concave part or a convex part is provided in an air-gap surface of a claw of the stator core. The air-gap is present between an inner surface of the stator and an outer surface of the rotor.

The present invention provides a compact and lightweight, low-cost, quite, low-vibration claw-pole type single-phase motor.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a claw-pole type single-phase motor in one embodiment of the present invention.

FIGS. 2A and 2B are diagrams showing the structure of the claw-pole type single-phase motor in one embodiment of the present invention.

FIGS. 3A and 3B are diagrams showing the structure of a claw-pole type single-phase motor in another embodiment of the present invention.

FIG. 4 is a diagram showing the configuration of a pulsation torque correction circuit of the claw-pole type single-phase motor of the present invention.

FIG. 5 is a diagram showing the operation of one embodiment of the present invention.

FIG. 6 is a diagram showing the configuration of a position-sensorless circuit of the claw-pole type single-phase motor of the present invention.

### DETAILED DESCRIPTION OF THE EMBODIMENTS

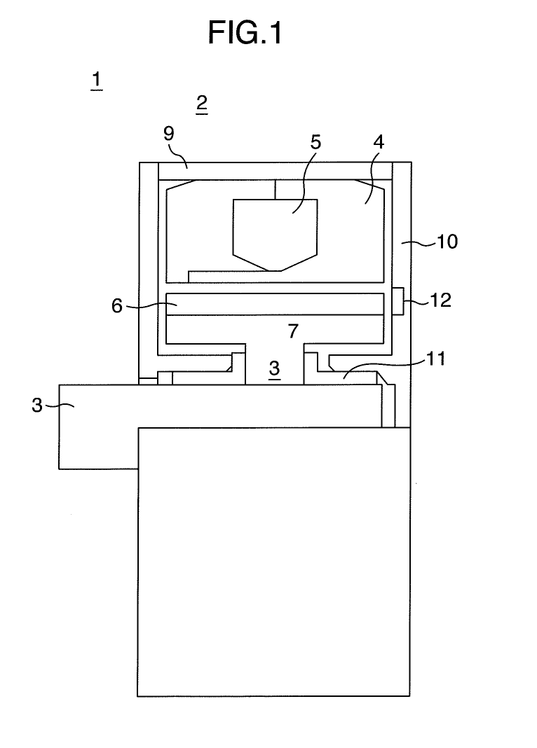

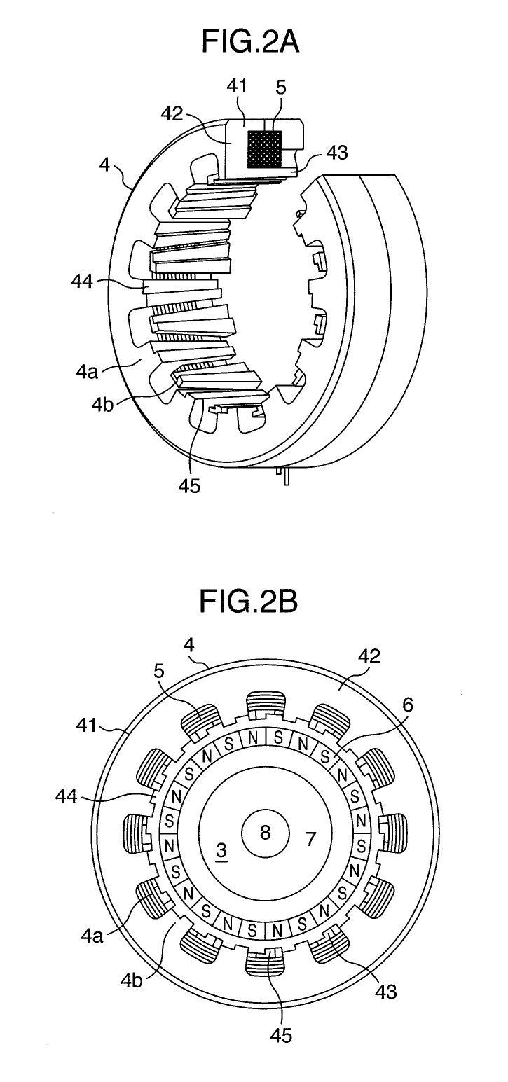

The configuration of a claw-pole type single-phase motor in one embodiment of the present invention comprising a stator, which is composed of a claw-pole type stator core and toroidally-wound stator windings, and a rotor that has permanent magnets will be described below with reference to FIG. 1 and FIGS. 2A and 2B.

Referring to the figures, a claw-pole type single-phase motor 1 comprises a stator 2 and a rotor 3. The rotor 3 comprises permanent magnets 6 and a rotor core 7 that constitutes the magnetic circuit and, via a shaft 8, transmits the power to an external device such as a pump.

On the other hand, the stator 2 comprises a stator core 4 and stator windings 5. In this example, the stator core 4 comprises two stator cores 4a and 4b (claw-shaped magnetic pole), which have almost the same shape, and they have the toroidally-wound stator winding 5 in the center as shown in the figure. When the power voltage is low (usually, a low voltage of 12V in a vehicle), no insulator is provided between the stator winding 5 and the stator core 4; when the power voltage is high, for example, in a hybrid vehicle, an insulator must be provided between them.

Although the figure shows the configuration of the motor alone, a control device such as an inverter may be provided integrally with the axial end of the driving motor, in which case, the motor has a compact configuration as an electric pump. It is also possible that, for driving a brushless motor, a position detector 12 is used to detect the magnetic flux leakage of the permanent magnets 6 on the rotor 3 to adjust the time, at which the current is supplied to the stator windings 5, for a quick start.

The stator core 4 and the stator windings 5 are stored in a housing 9, and the housing 9 is configured in such a way that end brackets 10 and a bearing 11 in the axial direction ends rotatably support the rotor 3.

FIGS. 2A and 2B show the configuration of the claw-pole type single-phase motor shown in FIG. 1.

FIG. 2A is a diagram showing the main part of the stator, and FIG. 2B is a cross section diagram of the front.

The magnetic circuit creates a magnetic path from one pole of the permanent magnet 6 to the pole of the neighboring permanent magnet 6 via air-gap, a claw 43, a side-face magnetic path 42, and a yoke 41 of one stator core 4a and via the yoke 41, side-face magnetic path 42, claw 43, and air-gap of another stator core 4b.

In the figure, the stator cores 4a and 4b, which configure the claw-pole type motor, hold the toroidally wound stator winding 5 from both axial sides as shown in the figure. The claw portion of the stator core 4 may have a shape that is parallel to the axis or, as shown in the figure, slightly skewed. The skewed shape makes the voltage, induced on the stator winding 5, to have a desired form with fewer torque ripples.

A concave part 44 is provided on the air-gap face in the rotor reverse-rotational direction (clockwise direction in this example) side of the claw portion of the stator core. This concave part generates an efficient cogging torque used to cover the two torque falls in one electrical-angle cycle, generated by the current flowing through the stator winding 5 and the magnetic flux of the permanent magnet rotor 3, and therefore reduces the torque pulsation.

The concave part 44 may have not only a strictly stepwise shape as shown in FIGS. 2A and 2B but also a round or tapered shape.

The cogging torque may be generated not only by the concave part 44. Because the core is a powder core, a die may be used to form a convex part in the axial direction that is used instead of the concave part. In this case, the convex part must be provided in the part in the rotational direction of the rotor.

As for the concave part 44, the convex part may have not only a strictly stepwise shape but also a round or tapered shape.

The stator cores 4a and 4b are powder cores made of magnetic particles that are several scores to several hundred micrometers in size. Therefore, in contrast to the conventional stator made of laminated cores, the stator made of powder cores is solid, strong, less-vibrating, and quite in structure. The shape described above reduces the torque pulsation and so makes the motor even less vibrating and quite.

The eddy current is difficult to flow through the powder core made of insulation-film coated magnetic particles. This decreases the core loss, and increases efficiency, of the motor. When the voltage of the dc power is low, the cost of the motor can be reduced because the stator winding 5 and the stator core 4 do not require insulation.

Because the toroidally-wound stator winding 5 is easy to manufacture and because the molding after the winding is easier than the molding of the stator winding wound on the slots of the conventional laminated cores, the space factor of the stator winding 5 in the storage space of the stator winding 5 is increased. A higher space factor, which decreases the resistance of the stator winding 5, makes the motor more efficient. In addition, a higher space factor, which decreases the thermal resistance between the stator winding 5 and the stator core 4, provides a driving motor that can withstand a heavy load. In other words, a higher space factor makes the driving motor compact and lightweight.

The stator core 4, which is manufactured by compacting magnetic particles, can be easily molded into a three-dimensional, complex shape such as the one shown in the figure. In addition, in contrast to the conventional stator core that is manufactured by punching thin steel plates into a desired form, the stator core 4 having the three-dimensional shape shown in the figures can be made of necessary materials. Therefore, the stator core 4 can be manufactured at a high material utilization rate and at a low cost.

The toroidally-wound stator winding 5 shortens the length of one winding wire, reduces the winding resistance and, so, makes the motor more efficient. In addition, unlike the motors in the examples of the disclosures, the stator winding 5 has not a coil end part that does not contribute to torque generation and, so, the motor becomes still more compact and lightweight.

As described above, the claw-pole type single-phase motor described above has high manufacturability because of fewer parts, a high material utilization rate, and high recyclability because of the use of powder cores. Thus, it can provide an efficient, compact and lightweight, and low-cost permanent magnetic motor.

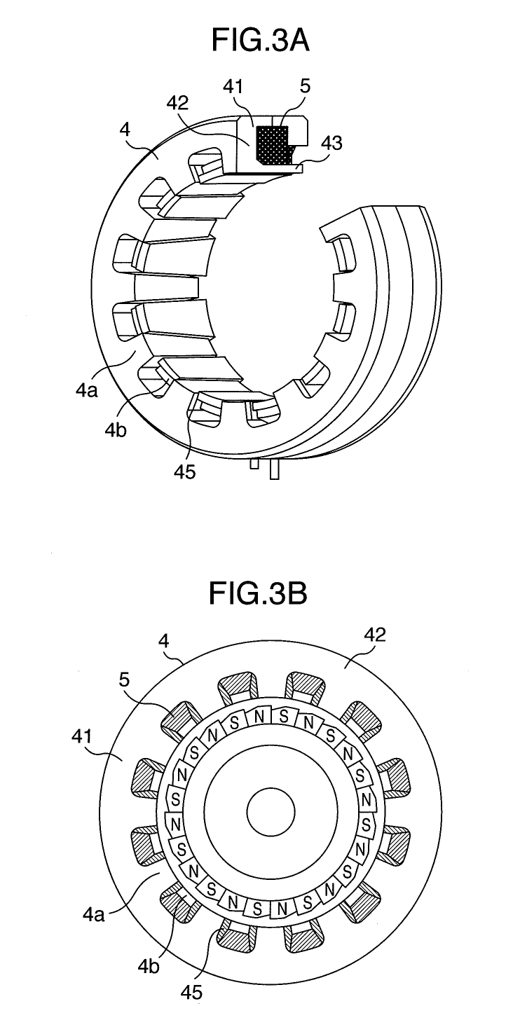

FIGS. 3A and 3B show one embodiment of the structure of another claw-pole type single-phase motor of the present invention.

The first difference between the structure of this embodiment and the structure shown in FIGS. 2A and 2B is that there is no concave part 44 on the air-gap face of a stator core 4. This structure makes the shapes of stator cores 4a and 4b completely the same, allowing stator cores to be manufactured with only one die. The second difference is in the shape of the permanent magnets. The shape of the stator core described above does not generate cogging torques efficient for smoothing the torques. To solve this problem, the permanent magnet is made to have an asymmetric shape in the circumference direction. More specifically, the air-gap length is increased in the rotational direction. The permanent magnet with this shape can be easily manufactured with the use of a plastic magnet and, so, there is no serious manufacturing problem.

The method described above requires only one die for manufacturing the stator core and provides a single-phase permanent magnet motor that generates less torque ripples.

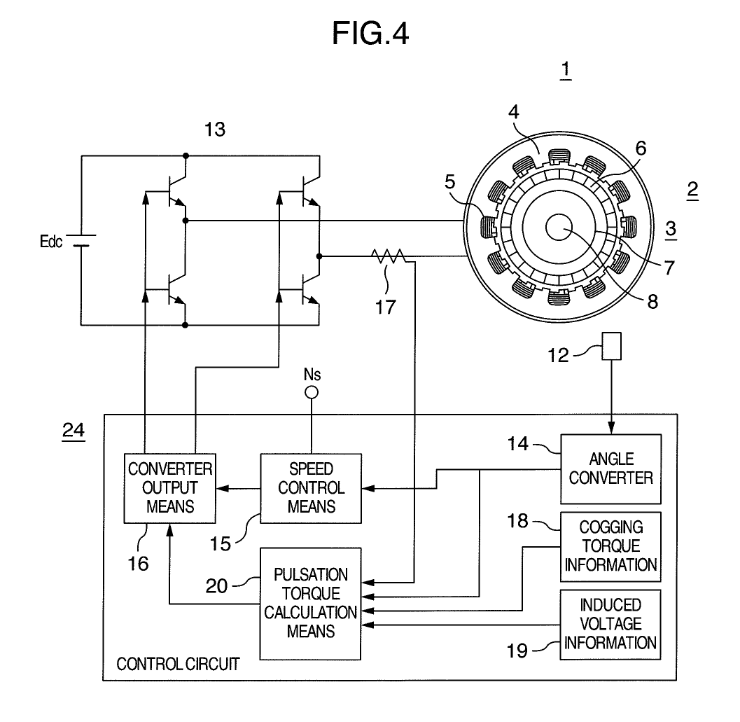

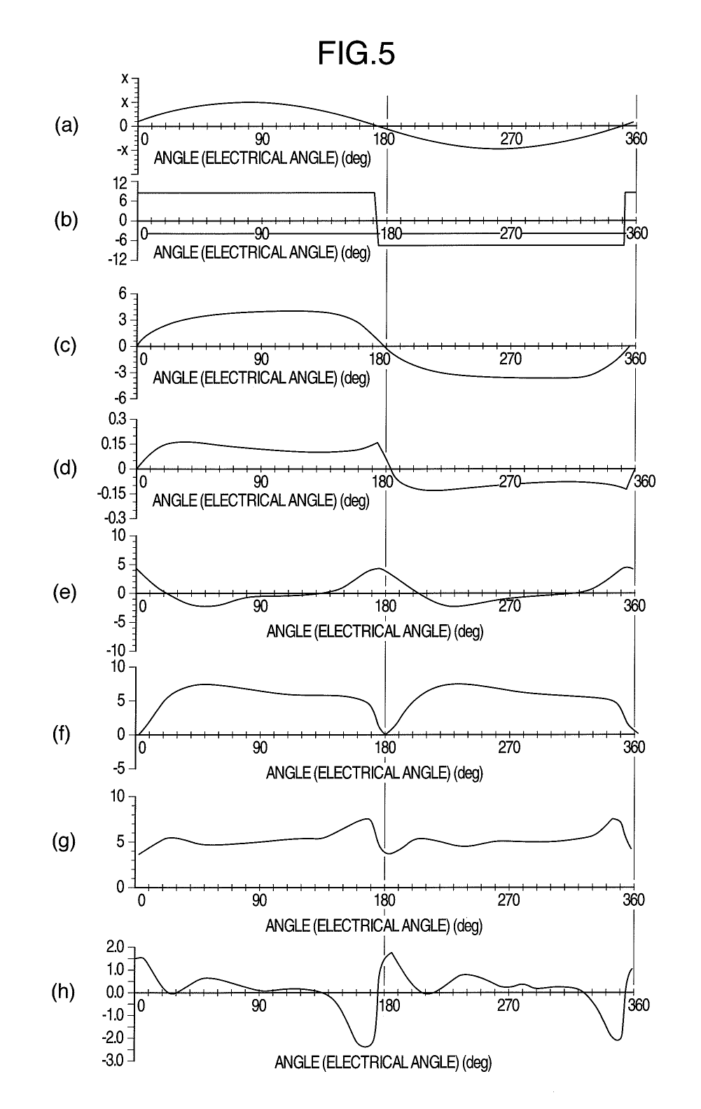

Next, FIG. 4 is a diagram showing the control configuration of the claw-pole type single-phase motor in one embodiment of the present invention. FIG. 5 is a diagram showing the operation.

Referring to FIG. 4, the control configuration of the single-phase motor comprises a converter 13 that supplies ac power from a dc power supply Edc to a claw-pole type single-phase motor 1, a control circuit 24 that controls the output current of the converter 13, and the claw-pole type single-phase motor 1.

The configuration of the claw-pole type single-phase motor 1 is the same as that of the claw-pole type single-phase motor 1 in FIG. 1.

The position detector 12 is provided on the stator 2 at the axial end of the permanent magnet 6 of the rotor 3. This position detector 12 detects the position of the permanent magnets 6 and, via the converter 13, supplies an efficient current to the claw-pole type single-phase motor 1. The stator winding 5 or the converter 13 of the claw-pole type single-phase motor 1 has a current sensor 17 that constantly monitors the current supplied to the stator winding 5.

Speed control means 15, one of the components of a control circuit 24, performs the proportional plus integral control operation as necessary based on a speed error obtained from the speed information, which is obtained by measuring the period of the half cycle of the position detector 12 via an angle converter 14, and a speed command Ns, and outputs the output signal from converter output means 16 to the converter 13 for controlling it. The operation described above sets the speed of the claw-pole type single-phase motor 1 to a desired speed.

The following describes the torque generation principle of the claw-pole type single-phase motor 1.

FIG. 5 shows the operation principle. The figure shows the operation when the motor rotates at a constant speed.

The horizontal axis indicates the position θ of the rotor in terms of electrical angle in the range from 0 to 360 degrees.

(a) shows the output signal of the position detector 12 that is output by detecting the magnetic flux leakage of the permanent magnet 6.

(b) shows the voltage vt(θ) applied to the stator winding 5 of the claw-pole type single-phase motor 1.

(c) shows the induced voltage E0(θ) to the stator winding 5 generated by the magnetic flux of the permanent magnet 6.

(d) shows the winding current iw(θ) that is determined by the voltage Vt(θ) shown in FIG. 5B, the induced voltage E0(θ) shown in (c), the resistance r and the inductance L of the stator winding 5.

[Expression 1]
Vt(θ)=(r+Lp)iw(θ)+E0(θ) (1)
where p indicates d/dt.

(e) shows the cogging torque Tc(θ) generated between the stator core 4 and the permanent magnet 6 when the current is not supplied.

(f) shows the torque Tw(θ) generated by the induced voltage and the winding current. The output P0w(θ), indicated by the product of the induced voltage E0(θ) in (c) and the current iw(θ) in (d), shows the output generated by the magnetic flux of the permanent magnet and the current of the stator winding.

(g) shows the total torque T(θ) of the driving motor.

This is the sum of the torque T0w(θ), generated by the induced voltage and the winding current, and the cogging torque Tc(θ).

The waveform is the same as that of the output when the rotor rotates at a constant speed.

The following describes the driving principle by referring to the waveforms of the single-phase motor shown in FIG. 5.

The waveform of the cogging torque of the claw-pole type single-phase motor 1 shown in FIG. 5 is as shown in (e) with respect to the rotational position, because the concave part 44 is provided only on one side of the claw surface of the stator core 4.

Next, the following describes the induced voltage, which is the main torque of the single-phase motor, and the torque T0w(θ) generated by the winding current. First, the induced voltage generally has a rectangular waveform such as the one shown in (c).

In principle, this waveform varies according to the shape of the claw on the stator core.

As shown in (a), the polarity of the applied voltage is switched at the zero-crossing point of the position detection output signal of the hall device (this signal has the sine waveform because the hall device is provided at some distance from the permanent magnet) provided at a position slightly ahead of the induced voltage in phase, and the voltage shown in (b) is applied to the stator winding 5. This causes the current shown in (d) to flow, and the torque is generated by the current and the induced voltage of the stator winding 5 as shown in (f). Because this is the output of single-phase driving, the torque falls twice near the zero of the induced voltage in the 360-degree period in principle and the waveform is the one shown in the figure. Adding the positive component of the cogging torque to those falls generates the total torque that is almost even as shown in (g).

Although not so smooth as a torque generated by a three-phase motor, the generated torque can be made smooth enough to be comparable to that of the three-phase motor. The torque can be made still smoother by adjusting the phase advance amount of the applied voltage with respect to the induced voltage and by adjusting the waveform of the applied voltage (for example, a smooth rise at rise time and a gradual fall at fall time). In addition, the problem of the compatibility relation between the waveform of the cogging torque and the torque generated by the induced voltage and the winding current is solved by optimally adjusting the cogging torque to the depressed position on the surface of the stator core 4 in order to make the output torque smooth with respect to the angle θ of the rotor.

Optimizing the claw shape of the stator core 4, the skew amount, and the concave part shape for the output torque described above smoothes the cogging torque described above and the torque generated by the stator winding current and the permanent magnet flux, thus making the single-phase motor quite and less vibrating.

Controlling the claw-pole type single-phase motor as described above provides a compact and lightweight, efficient, low-cost, quite single-phase permanent magnet motor and an electric pump and an electric fan that uses the single-phase permanent magnet motor.

Next, the following describes one embodiment of how to reduce the pulsation torque of the claw-pole type single-phase motor of the present invention. FIG. 4 is a diagram showing the embodiment.

Referring to FIG. 4, the control circuit 24 for reducing the pulsation torque of the claw-pole type single-phase motor of the present invention controls the converter 13, which supplies power to the claw-pole type single-phase motor 1, based on the information from the position detector 12, angle converter 14, and current sensor 17 described above and cogging torque information 18 and induced voltage information 19 that are stored in advance.

The angle converter 14, a calculation unit that uses the information from the position detector 12 to estimate the electrical angle θ of the rotor 3, calculates the average speed of the rotor 3 based on the positive/negative switching period of the output signal of the position detector 12 and, at the same time, calculates and estimates the angle of the rotor based on the elapsed time in the control period. In addition, the angle converter 14 determines the positive and negative power of the converter 13 based on the positive/negative information from the position detector 12.

Pulsation torque calculation means 20 calculates the average output torque and the pulsation torque from the output of the current sensor 17, the output of the angle converter 14, the cogging torque information 18, and the induced voltage information 19.

The following describes the method for calculating the pulsation torque in detail.

First, the electromagnetic torque Tw(θ) based on the information on the induced voltage E0(θ) induced by the magnetic flux of the permanent magnet and the current I(θ) flowing through the stator winding is calculated by the following expression.

$$\begin{matrix}[ Expression 2 ] & ( 2 ) \\ Tw ( θ ) = \frac{E 0 ( θ ) \vert ( θ )}{ω} & \end{matrix}$$

where, ω indicates rotational angle speed information,

E0(θ) indicates induced voltage information (stored in induced voltage information 19 in advance) for angle θ at speed ω and

I(θ) indicates current information obtained from current sensor.

Therefore, the total torque Tt(θ) generated by the single-phase permanent magnet motor is as follows.

[Expression 3]
Tt(θ)=Tcog(θ)+Tw(θ) (3)
where, Tcog(θ) indicates the cogging torque for the rotational angle (stored in the cogging torque information 18 in advance).

On the other hand, the average torque Tav(θ) is calculated by the following expression that calculates the average of the total torque Tt(θ) for one cycle (or half-cycle as necessary) of the electrical angle.

$$\begin{matrix}[ Expression 4 ] & ( 4 ) \\ Tav ( θ ) = \frac{2}{π} {\int }_{- π}^{π} Tt ( θ ) ⅆ θ & \end{matrix}$$

Therefore, the pulsation torque Tac(θ) is expressed by the following expression.
[Expression 5]
Tac(θ)=Tt(θ)−Tav(θ) (5)

In FIG. 4, the speed of the claw-pole type single-phase motor 1 is usually set by the speed control means 15 to a speed specified by the speed command Ns in the same way as described above. As described above, the proportional plus integral control operation and so on is performed, as necessary, based on the speed feedback information calculated from period of one cycle of the electrical angle of the position detector 12. On the other hand, it is possible to divide one cycle of the position detector 12 using the pulsation torque information, calculated by the pulsation torque calculation means 20, to generate the correction signal and, using this correction signal for correction control, to smooth the output torque of the single-phase permanent magnet motor.

FIG. 5 is a diagram showing the above-described control operation of the present invention.

(a) shows the output signal of the position detector 12. This signal may be set ahead in phase of the induced voltage shown in (c). The speed information of the permanent magnet rotor can be calculated from the period of the half-cycle or one cycle of this signal.

(b) shows the terminal voltage of the motor. Basically, the positive voltage signal is applied at the negative to positive zero-crossing point of the position detector. The amplitude of the voltage is adjusted via PWM (Pulse Width Modulation) and so on. A delay of a specific time from the zero-crossing time allows this signal to be set ahead or behind in phase of the induced voltage shown in (c).

(c) shows the induced voltage information for the rotational electrical angle. In general, this information is stored as an induced voltage constant, calculated by dividing the induced voltage by the rotational speed, and this constant can be converted to the induced voltage by multiplying the constant by the rotational speed.

(d) shows the current information that is obtained from the current sensor 17. This information is measured in advance and stored in the memory.

(e) shows the cogging torque information for the rotational electrical angle. This information is measured in advance and stored in the memory.

(f) shows the electromagnetic torque Tw(θ) generated by the magnetic flux (induced voltage) of the permanent magnet and the current flowing through the stator winding. This torque can be calculated by expression (2).

(g) shows the total torque that is the sum of the above-described torque Tw(θ) and the cogging torque. This torque is the one indicated by expression (3).

(h) shows the pulsation torque. This torque is the one calculated by expressions (4) and (5).

The converter output means 16 combines the output from the speed control means 15 and the output from the pulsation torque calculation means 20 to generate a signal for controlling the converter 13. The control described above provides a single-phase permanent magnet motor control device that has less torque ripples.

The control described above is performed to control a fan or a pump. The response frequency of the control is so low (several hertz) that the control operation is performed reliably.

The speed may be controlled for each electrical cycle, and the pulsation torque may be corrected for each multiple of one electrical cycle. The control operation may also be stopped when the speed command Ns signal is changed greatly as necessary.

Because, in contrast to a general three-phase motor, a single-phase permanent magnet motor requires one set of windings and one hall device (three for three-phase motor), and the conversion circuit can be configured by an H bridge, as shown in FIG. 1, the single-phase permanent magnet motor requires only four components and so the cost is low. On the other hand, a quite, low-vibrating permanent magnet motor control device, which performs the above control to smooth the operation torque and is comparable to a three-phase motor, can be provided.

In the above configuration, the cogging torque information 18 is proportional to the square of the air-gap magnetic flux density, and the induced voltage information 19 is proportional to the air-gap magnetic flux density, and the air-gap magnetic flux density is information that is proportional to the temperature. Therefore, the more precise control is possible, for example, by providing a temperature sensor in the single-phase permanent magnet motor control device to correct the cogging torque information 18 and the induced voltage information 19.

The speed can be controlled for each half period of the electrical angle, and the period can be divided into multiples to control the pulsation torque correction, for more precise control.

Considering the precision and the temperature dependency of the constants, the pulsation torque correction can be controlled more reliably in some cases only by the proportional control method with some deviation rather than by the integral control with zero deviation.

This claw-pole type single-phase permanent magnet motor, when used for an electric fan or an electric pump, simplifies the configuration, and reduces the sound and the vibration, of the electric fan or the electric pump.

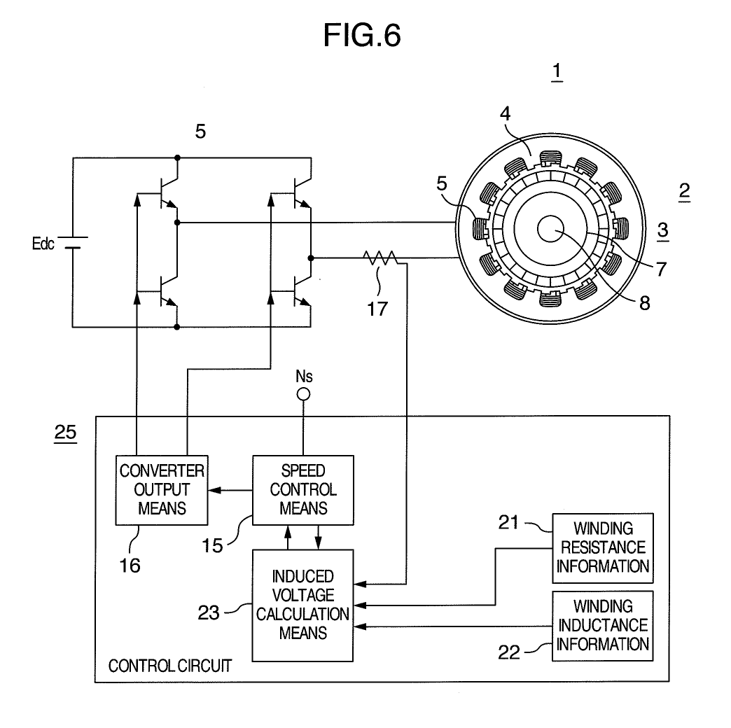

Next, FIG. 6 shows the configuration of the position-sensorless driving circuit of the claw-pole type single-phase motor of the present invention. The same numeral is used to denote the same part in FIG. 4.

The present invention provides a control circuit 25 that comprises induced voltage calculation means 23, which calculates the induced voltage of the claw-pole type single-phase motor 1 from the information received from the current sensor 17 and winding resistance information 21 and winding inductance information 22 on the stator winding 5 both of which are stored in advance, the speed control means 15, and the converter output means 16 which combines the signals from the former. The present invention determines the position of the rotor 3 based on the induced voltage information obtained from the induced voltage calculation means 23 described above and determines the time at which the voltage is to be applied. This configuration allows the power to be supplied continuously and the single-phase sensorless operation to be performed with few torque pulsations. In this way, the sensorless operation can be performed without a magnetic pole position detector.

The following describes the operation of the present invention with reference to FIG. 5.

FIG. 5(b) shows the terminal voltage Et(θ) of the motor, where the magnitude of the terminal voltage is adjusted, for example, via PWM (Pulse Width Modulation). The PWM is usually constant between positive half-cycle and the negative half-cycle. A delay of a specific time from the zero-crossing time allows this signal to be set ahead or behind in phase of the induced voltage shown in FIG. 5(c).

FIG. 5(c) shows the induced voltage for the rotational electrical angle.

The waveform of the induced voltage is made asynchronous by the shape of the stator core on the air-gap face described above. The induced voltage E0(θ) can be calculated from the expression given below by the induced voltage calculation means 23 using the information on the terminal voltage Et(θ), current sensor i(θ), resistance r of the winding, and inductance L of the winding.

$$\begin{matrix}[ Expression 6 ] & ( 6 ) \\ E 0 ( θ ) = Et ( θ ) - ( r + L ) \frac{ⅆ i ( θ )}{ⅆ t} & \end{matrix}$$

where Et(θ) is the terminal voltage.

r indicates the resistance of the winding.

L indicates the inductance of the winding.

i(θ) is the current value measured by the current sensor.

According to the present invention, the speed of the claw-pole type single-phase motor 1 is controlled by the speed control means 15 in FIG. 6 as described above so that its speed is set generally to the speed specified by the speed command Ns. The speed information on the single-phase permanent magnet motor is required to control the speed. The speed feedback information, calculated for the period of one cycle of the electrical angle, is used from the induced voltage information obtained by the induced voltage calculation means 23 described above, and the proportional plus integral control operation is performed, as necessary, according to the speed error to set the speed to a constant speed. The control described above causes the motor to operate at the speed of Ns.

According to the present invention, the induced voltage calculation means 23 performs the positive/negative switching of the terminal voltage Et(θ) based on the induced voltage information obtained by expression (6). For example, the terminal voltage is switched from positive to negative when the induced voltage falls from the maximum positive voltage to a predetermined value or lower. The voltage controlled in this way is the terminal voltage shown in FIG. 5(b).

In the example shown here, the voltage is controlled to a fixed voltage to the next switching point. It is also possible to change the voltage as necessary at a rise time or a fall time.

This control allows the current to be continuously controlled in the sensorless mode.

Although only a fixed number of rotations is described in the above example, the induced voltage can be calculated in the acceleration of the half cycle of the electrical angle by reducing the inertia of the rotor at startup time and the sensorless operation can be started.

This configuration does not involve a limitation on the usage rating in the engine room due to a hall device provided in the engine room for detecting the positions of magnetic poles, which is described in the conventional example, and eliminates the need for the sensorless mode in which power-off period is provided, thus providing an efficient, low-vibrating, and quite motor.

As described above, the present invention comprises a dc power supply, a converter that converts a dc current to an ac current, a control device that controls this converter, and a single-phase permanent magnet motor control device that is driven by them, wherein this single-phase permanent magnet motor control device comprises means for measuring a motor current, means for measuring a terminal voltage, means for correcting the impedance fall of motor constants, and means for calculating an induced voltage by the control to form a single-phase position-sensorless permanent magnet motor control device for determining the direction of the terminal voltage using the value of the calculated induced voltage. Because, in contrast to a general three-phase motor, a single-phase position-sensorless permanent magnet motor requires one set of windings and one hall device (three for three-phase motor), and the conversion circuit can be configured by an H bridge, as shown in FIG. 1, the single-phase position-sensorless permanent magnet motor requires only four components and so the cost is low. On the other hand, a quite, low-vibrating permanent magnet motor control device, which performs the above control to smooth the operation torque and is comparable to a three-phase motor, can be provided.

This single-phase permanent magnet motor control device, when used for an electric fan or an electric pump, simplifies the configuration and provides a low-cost, compact and lightweight, quite, low-vibrating electric fan or electric pump (for example, the quietness and the low price are most advantageous when the device is mounted in the passenger room of a vehicle).

In the description above, a system using a microcomputer is assumed as the control circuit. Instead, the single-phase position-sensorless permanent magnet motor control device having the control circuit 25 including the induced voltage calculation means 23 can also be implemented by discrete circuits such as amplifiers, resistors, and capacitors. In this case, the device can be built at a lower cost.

Even when there is no information on the induced voltage at start time and how the voltage is applied is not known, it is possible to provide a mechanism for supplying a current to the stator winding. This mechanism adds the polarity determination function that determines the current direction, in which the rotor can output positive torque, to start the operation reliably.

It should be further understood by those skilled in the art that although the foregoing description has been made on embodiments of the invention, the invention is not limited thereto and various changes and modifications may be made without departing from the spirit of the invention and the scope of the appended claims.

1. A single-phase claw-pole type motor comprising a stator, which comprises a claw-pole type stator core and toroidally-wound single-phase stator windings, and a rotor that has alternate polarities, wherein a concave part is provided on an air-gap surface of claws of said stator core.

2. The claw-pole type single-phase motor according to claim 1 wherein said concave part is provided on said claws of said stator core in a reverse rotation direction side of said rotor.

3. The claw-pole type single-phase motor according to claim 1 wherein an end of each of said claws of said stator core is skewed.

4. The claw-pole type single-phase motor according to claim 1 wherein said claw-pole type single-phase motor is driven by a converter that converts a direct current to an alternate current according to a position of said rotor.

5. A claw-pole type single-phase motor system comprising the claw-pole type single-phase motor according to claim 1 and a converter that supplies an alternate current from a direct current power supply to a single-phase permanent magnet motor, said claw-pole type single-phase motor system further comprising:
a control circuit that controls said converter so that pulsation torque of said claw-pole type single-phase motor is reduced based on cogging torque of said single-phase claw-pole type motor, waveform information on an induced voltage, and information on a motor current.

6. A claw-pole type single-phase motor system comprising the claw-pole type single-phase motor according to claim 1, a converter that supplies an alternate current from a direct current power supply to a single-phase permanent magnet motor, and a control device that controls said converter, wherein
said control device comprises means for calculating an induced voltage from motor current information, detected by motor current measuring means, and motor constant information for determining a value of a terminal voltage based on a value of the calculated induced voltage.

7. An electric pump, an electric fan, and a vehicle comprising the claw-pole type single-phase motor according to claim 1.

8. The claw-pole type single-phase motor according to claim 1 wherein said stator core is configured by compacting magnetic powder.

9. A single-phase claw-pole type motor comprising a stator, which comprises a claw-pole type stator core and toroidally-wound single-phase stator windings, and a rotor that has alternate polarities, wherein a convex part is provided on an end surface of claws of said stator core.

10. The claw-pole type single-phase motor according to claim 9 wherein said convex part is provided on said claws of said stator core in a rotation direction side of said rotor.

11. A single-phase claw-pole type motor comprising a stator, which comprises a claw-pole type stator core and toroidally-wound single-phase stator windings, and a rotor that has alternate polarities, wherein a shape of each permanent magnet on said rotor is asynchronous in a circumference direction.

12. A single-phase claw-pole type motor comprising a stator, which comprises a claw-pole type stator core and toroidally-wound single-phase stator windings, and a rotor that has alternate polarities wherein
said stator core is configured by compacting magnetic powder and said single-phase claw-pole type motor is driven by a converter that converts a direct current to an alternate current according to a position of said rotor.
